(19) United States
(12) Patent Application Publication
(10) Pub. No.: US 2021/0376431 A1
(43) Pub. Date: Dec. 2, 2021

(54) ENERGY STORAGE DEVICE

(71) Applicant: Robert Bosch GmbH, Stuttgart (DE)

(72) Inventor: Yukio ENOMOTO, Kyoto-shi, Kyoto (JP)

(21) Appl. No.: 16/637,346

(22) PCT Filed: Oct. 16, 2018
(86) PCT No.: PCT/EP2018/078264

§ 371 Date: Feb. 7, 2020

(30) Foreign Application Priority Data
Oct. 17, 2017 (JP) 2017-201207

(51) Int. Cl. H01M 50/552; H01M 50/562; H01M 50/553; H01G 11/74; H01G 11/78

(52) U.S. Cl. CPC H01M 50/561; H01M 50/562; H01G 11/78; H01G 11/74; H01M 50/553

(57) ABSTRACT

An energy storage device includes an outer case on which an external terminal is mounted; an electrode assembly housed in the outer case; a conductive shaft portion formed using a material different from a material for forming the external terminal, and having a swaged portion connected to the external terminal at one end thereof in an axial direction; a conductive plate portion housed in the outer case, to which the other end of the conductive shaft portion is connected, and the electrode assembly is connected. The external terminal has a plating layer or an alumite treated layer on a surface thereof which is brought into contact with the swaged portion.

### TECHNICAL FIELD

The present invention relates to an energy storage device which includes an external terminal.

### BACKGROUND ART

A chargeable and dischargeable energy storage device is used in various equipment such as a mobile phone and an automobile. A vehicle which uses electric energy as a power source such as an electric vehicle (EV) or a plug-in hybrid electric vehicle (PHEV) requires large energy. Accordingly, an energy storage module of a large capacity which includes a plurality of energy storage devices is mounted on the vehicle.

In general, an energy storage device is configured such that an electrode assembly formed by stacking or winding a positive electrode plate and a negative electrode plate with a separator interposed between the positive electrode plate and the negative electrode plate is gas-tightly housed in a case together with an electrolyte solution. A positive electrode external terminal and a negative electrode external terminal electrically connected to the electrode assembly via current collectors are mounted on a lid plate of the case.

A gasket or an insulation plate is disposed between the case and the terminal and between the case and the current collector.

Patent document 1 discloses a lithium ion secondary battery having a prismatic case. Through holes are formed in the lid of the case. A rod like barrel portion is inserted into the through hole, one end portion of the barrel portion is connected to a first flange portion in the case and the other end portion of the barrel portion is connected to a terminal plate (external terminal). A tab of the electrode assembly is connected to the first flange portion.

### PRIOR ART DOCUMENT

### Patent Document

Patent Document 1: JP-A-2016-91659

### SUMMARY OF THE INVENTION

### Problems to be Solved by the Invention

Such an energy storage device is requested to exhibit favorable mechanical and electrical connecting properties between the external terminal and the current collector, favorable gas-tightness and favorable property of preventing a leakage of a liquid from the energy storage device and intrusion of moisture into the energy storage device.

The present invention has been made in view of such circumstances, and it is an object of the present invention to provide an energy storage device which exhibits favorable gas-tightness and can prevent a leakage of a liquid from the energy storage device and intrusion of moisture into the energy storage device.

### Means for Solving the Problems

An energy storage device according to the present invention includes: an outer case on which an external terminal is mounted; an electrode assembly housed in the outer case; a conductive shaft portion formed using a material different from a material for forming the external terminal, and having a swaged portion connected to the external terminal at one end thereof in an axial direction; and a conductive plate portion housed in the outer case, to which the other end of the conductive shaft portion is connected, and the electrode assembly is connected, wherein the external terminal has a plating layer or an alumite treated layer on a surface thereof which is brought into contact with the swaged portion.

### Advantages of the Invention

According to the present invention, the external terminal has the plating layer or the alumite treated layer on the surface thereof which is brought into contact with the swaged portion and hence, it is possible to provide an energy storage device which exhibits favorable corrosion resistance and can suppress lowering of electric performance and shortening of lifetime.

### BRIEF DESCRIPTION OF THE DRAWINGS

FIG. 1 is a perspective view of an energy storage device according to a first embodiment.

FIG. 2 is a front view of the energy storage device.

FIG. 3 is a cross-sectional view taken along line III-III in FIG. 2.

FIG. 4 is a partially enlarged cross-sectional view taken along line IV-IV in FIG. 2.

FIG. 5 is a partial cross-sectional view of an energy storage device according to a second embodiment.

### MODES FOR CARRYING OUT THE INVENTION

### Summary of the Embodiment

An energy storage device of this embodiment includes: an outer case on which an external terminal is mounted; an electrode assembly housed in the outer case; a conductive shaft portion formed using a material different from a material for forming the external terminal, and having a swaged portion connected to the external terminal at one end thereof in an axial direction; and a conductive plate portion housed in the outer case, to which the other end of the conductive shaft portion is connected, and the electrode assembly is connected, wherein the external terminal has a plating layer or an alumite treated layer on a surface thereof which is brought into contact with the swaged portion.

Different kinds of metals are brought into contact with each other at a contact portion between the swaged portion and the external terminal and hence, assuming a case where a liquid such as water, for example, intrudes into the contact portion so that the swaged portion and the external terminal become conductive with each other through the liquid, there is a concern that a galvanic corrosion occurs. When ionization tendency of the external terminal is larger than ionization tendency of the swaged portion, the external terminal corrodes.

With the above-mentioned configuration, the external terminal has the plating layer or the alumite treated layer and hence, favorable corrosion resistance can be acquired. Accordingly, it is possible to suppress the lowering of electric performance and the shortening of lifetime of the energy storage device.

The conductive plate portion is formed in a plate shape extending substantially parallel to the lid plate of the outer case, having a first surface to which the other end of the conductive shaft portion is connected, having a second surface to which a tab of the electrode assembly extending toward the lid plate is connected, wherein a size of the conductive plate portion and a size of the tab in a planar direction of the lid plate may be set larger than a size of the external terminal.

With the above-mentioned configuration, the conductive plate portion is formed in a plate shape extending substantially parallel to the lid plate and hence, a volume which the conductive plate portion occupies in the outer case is small. Accordingly, volume occupancy of the electrode assembly in the outer case can be increased so that energy density of the energy storage device can be enhanced. In spite of the fact that a volume which the conductive plate portion occupies in the outer case is small, the second surface of the conductive plate portion to which the tab is connected can ensure a large area. Accordingly, sizes of the conductive plate portion and the tabs in the planar direction can be set larger than a size of the external plate in the planar direction so that a contact area between the tabs and the conductive plate portion can be increased whereby a resistance loss of a current path in the energy storage device can be made small. Accordingly, even when a large current flows in the energy storage device, the current path is minimally fused.

Ionization tendency of the plating layer may be larger than ionization tendency of the conductive shaft portion, and may be smaller than ionization tendency of the external terminal.

When ionization tendencies are decreased in the order of the external terminal, the plating layer, and the conductive shaft portion, a potential difference between the conductive shaft portion and the plating layer becomes smaller than a potential difference between the conductive shaft portion and the external terminal. Accordingly, it is possible to suppress the occurrence of galvanic corrosion more favorably.

The external terminal may be formed using aluminum, and the conductive shaft portion may be formed using copper.

The difference between ionization tendency of aluminum and ionization tendency of copper is large and hence, galvanic corrosion is liable to occur at a contact portion between the external terminal and the conductive shaft portion.

With the above-mentioned configuration, the external terminal has the plating layer or the alumite treated layer and hence, it is possible to suppress movement of ions thus suppressing occurrence of galvanic corrosion favorably.

### First Embodiment

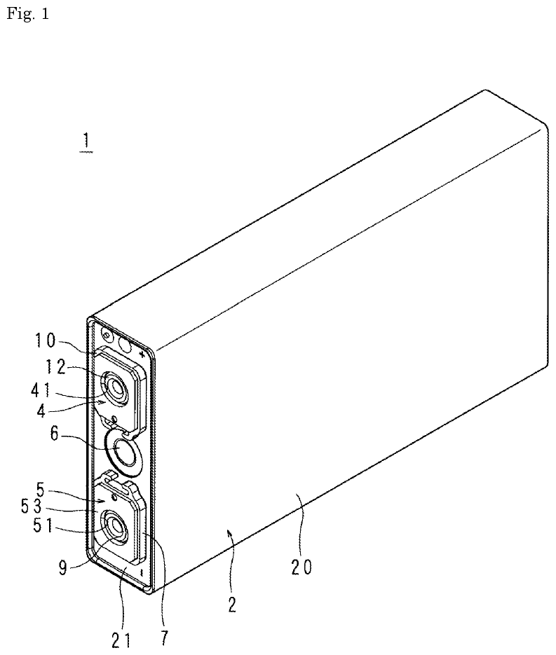

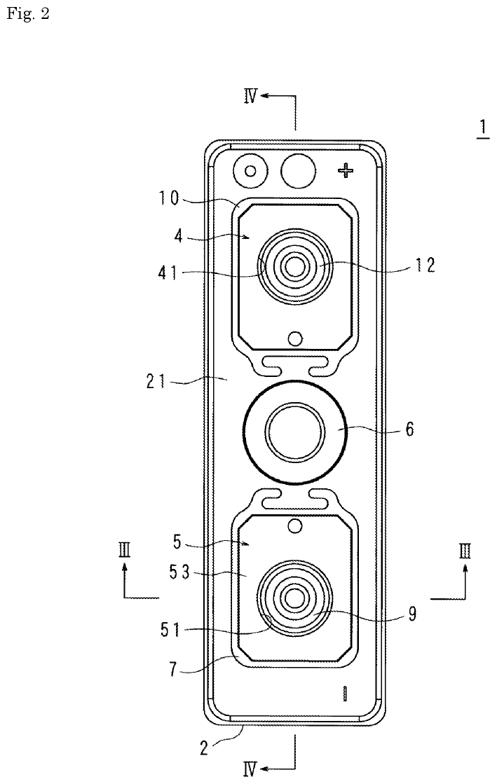

Hereinafter, the present invention is described with reference to drawings showing an energy storage device according to an embodiment. FIG. 1 is a perspective view of the energy storage device according to the first embodiment, and FIG. 2 is a front view of the energy storage device. Hereinafter, the description is made with respect to a case where the energy storage device 1 is a lithium ion secondary battery. However, the energy storage device 1 is not limited to a lithium ion secondary battery.

As shown in FIG. 1, the energy storage device 1 includes: a case 2 having a lid plate 21 and a case body 20; a positive electrode terminal 4; a negative electrode terminal 5; outer gaskets 7, 10; a rupture valve 6, and current collectors 9, 12. The positive electrode terminal 4 has a recessed portion 41 at an approximately center portion thereof, and an end portion of the current collector 12 is mechanically and electrically connected to the recessed portion 41. The negative electrode terminal 5 has a recessed portion 51 at an approximately center portion thereof, and an end portion of the current collector 9 is mechanically and electrically connected to the recessed portion 51. The negative electrode terminal 5 has a plating layer 53 on a surface thereof. The detailed connecting structures of the current collectors 9, 12 are described later.

The case 2 is, for example, made of metal such as aluminum, an aluminum alloy, stainless steel or a synthetic resin. The case 2 has a rectangular parallelepiped shape, and accommodates the electrode assembly 3 described later, and an electrolyte solution (not shown in the drawing). In this embodiment, the lid plate 21 is disposed on a mounting surface of the energy storage device 1 (not shown in the drawing) in a vertically extending manner. The lid plate 21 may be disposed in an upwardly facing manner in FIG. 1.

As shown in FIG. 2, the positive electrode terminal 4 is disposed on one end portion of an outer surface of the lid plate 21 by way of the outer gasket 10, and the negative electrode terminal 5 is disposed on the other end portion of the outer surface of the lid plate 21 by way of the outer gasket 7. The positive electrode terminal 4 and the negative electrode terminal 5 are respectively configured such that a flat outer surface of the electrode terminal is exposed, and a conductive member such as a bus bar (not shown in the drawing) is welded to the outer surface. The rupture valve 6 is disposed between the positive electrode terminal 4 and the negative electrode terminal 5 formed on the lid plate 21.

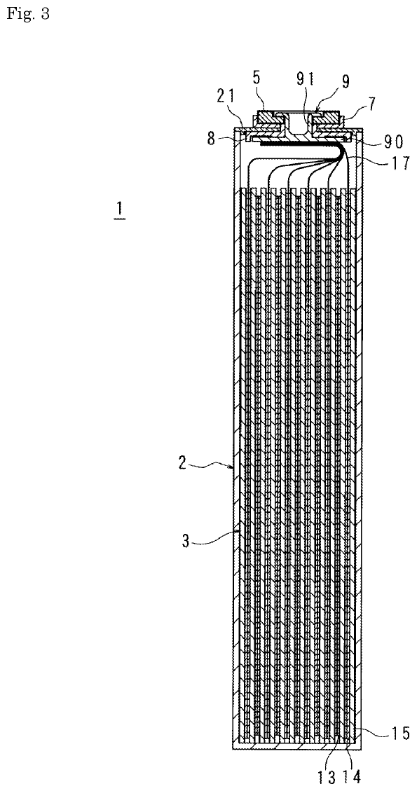

FIG. 3 is a cross-sectional view taken along line III-III in FIG. 2. As shown in FIG. 3, the electrode assembly 3 includes a plurality of positive electrode plates 13, a plurality of negative electrode plates 14, and a plurality of separators 15. The positive electrode plate 13, the negative electrode plate 14, and the separator 15 respectively have a rectangular shape as viewed in a lateral direction in FIG. 3. The plurality of positive electrode plates 13 and the plurality of negative electrode plates 14 are stacked such that the positive electrode plate 13 and the negative electrode plate 14 are alternately stacked with the separator 15 interposed between the positive electrode plate 13 and the negative electrode plate 14. FIG. 3 shows a state where negative electrode tabs 17 respectively extending from the negative electrode plates 14 are made to overlap with each other on a distal end side of the negative electrode plates 14, and are joined to an inner surface (second surface) of a conductive plate portion 90. The negative electrode tabs 17 are accommodated in the inside of the case 2 in a bent posture so as to enhance energy density of the energy storage device 1 (so as to make a space occupied by a current path between the negative electrode terminal 5 and the negative electrode plates 14 small). Although not shown in the drawing, positive electrode tabs 16 (described later) extending from the positive electrode plates 13 have the same configuration as the negative electrode tabs 17.

The electrode assembly 3 may be a winding type electrode assembly obtained by winding an elongated positive electrode plate 13 and an elongated negative electrode plate 14 with a separator 15 interposed between the positive electrode plate 13 and the negative electrode plate 14 in a flat shape.

The mounting structure of the current collector 9 is described later.

The positive electrode plate 13 is obtained by forming a positive active material layer on both surfaces of a positive electrode substrate foil which is a plate-like (sheet-like) or an elongated strip-shaped metal foil made of aluminum, an aluminum alloy or the like. The negative electrode plate 14 is obtained by forming a negative active material layer on both surfaces of a negative electrode substrate foil which is a plate-like (sheet-like) or elongated strip-shaped metal foil made of copper, a copper alloy or the like.

As a positive active material used for forming the positive active material layer or as a negative active material used for forming the negative active material layer, a known material can be used provided that the positive active material and the negative active material can occlude and discharge lithium ions.

As the positive active material, for example, a polyanion compound such as LiMPO₄, LiM₂SiO₄, LiMBO₃ (M being one kind or two or more kinds of transition metal elements selected from a group consisting of Fe, Ni, Mn, Co and the like), a spinel compound such as lithium titanate or lithium manganate, lithium transition metal oxide such as LiMO₂ (M being one kind or two or more kinds of transition metal elements selected from a group consisting of Fe, Ni, Mn, Co and the like) or the like can be used.

As the negative active material, for example, besides lithium metal and a lithium alloy (lithium-aluminum, lithium-silicon, lithium-lead, lithium-tin, lithium-aluminum-tin, lithium-gallium, and a lithium metal containing alloy such as a wood alloy), an alloy which can occlude or discharge lithium ions, a carbon material (for example, graphite, hardly graphitizable carbon, easily graphitizable carbon, low-temperature sintered carbon, amorphous carbon or the like), metal oxide, lithium metal oxide (Li₄Ti₅O₁₂ or the like), a polyphosphoric acid compound and the like can be named.

The separator 15 is formed using a sheet-like or a film-like material into which an electrolyte solution infiltrates. As a material for forming the separator 15, for example, a woven fabric, a non-woven fabric, and a sheet-like or film-like microporous resin can be named. The separator 15 separates the positive electrode plate 13 and the negative electrode plate 14 from each other and, at the same time, holds an electrolyte solution between the positive electrode plate 13 and the negative electrode plate 14.

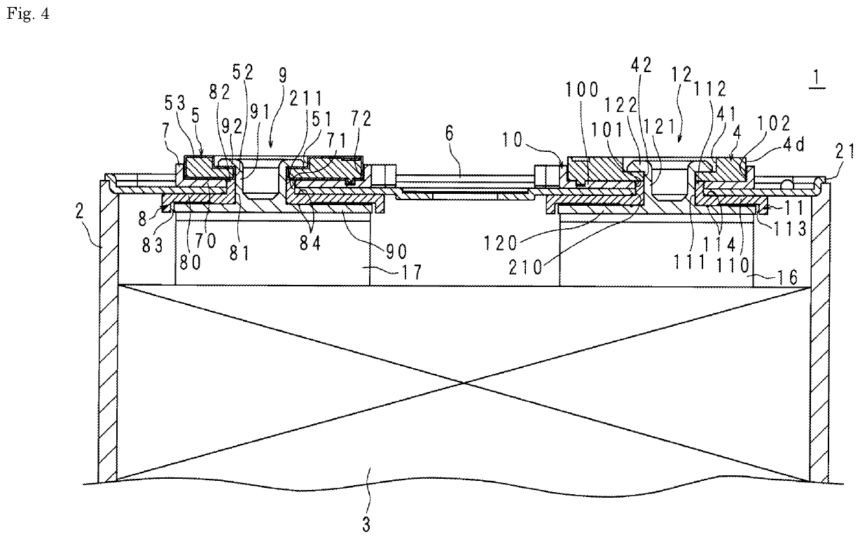

FIG. 4 is a partially enlarged cross-sectional view taken along line Iv-Iv in FIG. 2. Two through holes 210, 211 are formed in the lid plate 21 in a spaced apart manner in a longitudinal direction of the lid plate 21. The rupture valve 6 is disposed between the through holes 210, 211.

As shown in FIG. 4, the energy storage device 1 includes the negative electrode terminal 5, the outer gasket 7, an inner gasket 8, and the current collector 9 in the vicinity of the through hole 211.

The current collector 9 is made of copper, and includes the conductive plate portion 90, a conductive shaft portion 91, and a swaged portion 92. The conductive plate portion 90 is disposed inside the lid plate 21. The cylindrical conductive shaft portion 91 is disposed at an approximately center portion of an outer surface (first surface) of the conductive plate portion 90, and passes through the through hole 211. The swaged portion 92 is formed on one end of the conductive shaft portion 91 in an axial direction of the conductive shaft portion 91.

The conductive shaft portion 91 may be integrally formed with the conductive plate portion 90. Alternatively, the conductive shaft portion 91 may be formed as a body separate from the conductive plate portion 90 and may be joined to the conductive plate portion 90 by welding, swaging or the like. The conductive shaft portion 91 may be a solid portion.

The inner gasket 8 is made of a synthetic resin such as polyphenylene sulfide (PPS) or polypropylene (PP), for example. The inner gasket 8 has a plate portion 80, an insertion hole 81, a boss 82, an edge portion 83, and compressed convex portions 84. The plate portion 80 is interposed between the conductive plate portion 90 and an inner surface of the lid plate 21, and has the insertion hole 81 at an approximately center portion thereof. The cylindrical boss 82 is disposed so as to surround the insertion hole 81, and covers an outer periphery of the conductive shaft portion 91. On an edge of an inner surface of the plate portion 80, the edge portion 83 which protrudes inward is formed. The edge portion 83 covers a side surface of the conductive plate portion 90. On both surfaces of the plate portion 80 on an outer peripheral side of the boss 82, the ring-shaped compressed convex portion 84 is formed respectively. The compressed convex portion 84 is not limited to a ring shape, and a plurality of compressed convex portions 84 may be formed in a spaced apart manner in a circumferential direction. The compressed convex portions 84 are compressed by pressing at the time of swaging.

The negative electrode terminal 5 is made of aluminum, and has a rectangular plate shape. The negative electrode terminal 5 has a circular-hole-shaped recessed portion 51 on a first surface (outer surface) thereof. In a center portion of a bottom surface of the recessed portion 51, an insertion hole 52 into which the conductive shaft portion 91 is inserted is formed.

The negative electrode terminal 5 has a plating layer 53 formed by Ni plating on the surface thereof.

The negative electrode terminal 5 is made of aluminum, and the swaged portion 92 is made of copper and hence, there is the large difference in ionization tendency between the negative electrode terminal 5 and the swaged portion 92. Assuming a case where a liquid such as water intrudes into the contact portion between the negative electrode terminal 5 and the swaged portion 92 so that the swaged portion 92 and the negative electrode terminal 5 become conductive with each other through the liquid, there is a concern that a galvanic action (galvanic corrosion) occurs.

In a case where an Ni plating layer is applied to the whole surface of the current collector 9 for preventing the occurrence of galvanic corrosion, although galvanic corrosion which occurs between the swaged portion 92 and the negative electrode terminal 5 can be suppressed, there is a concern that Ni powder is mixed into the negative electrode tabs 17 at the time of welding the conductive plate portion 90 and the negative electrode tabs 17 to each other by ultrasonic welding.

In this embodiment, the plating layer 53 made of Ni is formed on the negative electrode terminal 5. The Ni plating may be performed by either one of electrolytic Ni plating or electroless Ni plating.

The plating layer 53 may be formed on at least a portion where the conductive shaft portion 91 and the negative electrode terminal 5 are brought into contact with each other.

The outer gasket 7 is made of a synthetic resin such as PPS or PP. The outer gasket 7 has a plate portion 70, an insertion hole 71, and an edge portion 72. The plate portion 70 is interposed between an outer surface of the lid plate 21 and an inner surface of the negative electrode terminal 5. The insertion hole 71 is formed at an approximately center portion of the plate portion 70, and the boss 82 is inserted into the insertion hole 71. On a peripheral edge of an outer surface of the plate portion 70, the edge portion 72 which protrudes outward is formed. The edge portion 72 covers a side surface of the negative electrode terminal 5.

Respective sizes (area) of the conductive plate portion 90 and the negative electrode tabs 17 in a planar direction (longitudinal direction) of the lid plate 21 are set larger than a size of the negative electrode terminal 5 in a planar direction (longitudinal direction) of the lid plate 21.

As shown in FIG. 4, the energy storage device 1 includes the positive electrode terminal 4, the outer gasket 10, an inner gasket 11, and the current collector 12 in the vicinity of the through hole 210.

The current collector 12 is made of aluminum, and includes a conductive plate portion 120, a conductive shaft portion 121, and a swaged portion 122. The conductive plate portion 120 is disposed inside the lid plate 21. The cylindrical conductive shaft portion 121 is disposed at an approximately center portion of the conductive plate portion 120, and passes through the through hole 210. The swaged portion 122 is formed on an end portion of the conductive shaft portion 121.

The conductive shaft portion 121 may be integrally formed with the conductive plate portion 120. Alternatively, the conductive shaft portion 121 may be formed as a body separate from the conductive plate portion 120 and may be joined to the conductive plate portion 120 by welding, swaging or the like.

The inner gasket 11 is made of a synthetic resin such as PPS or PP, for example. The inner gasket 11 has a plate portion 110, an insertion hole 111, a boss 112, an edge portion 113, and compressed convex portions 114. The plate portion 110 is interposed between the conductive plate portion 120 and the inner surface of the lid plate 21, and has the insertion hole 111 at an approximately center portion thereof. The cylindrical boss 112 is disposed so as to surround the insertion hole 111, and covers an outer periphery of the conductive shaft portion 121. On a peripheral edge of an inner surface of the plate portion 110, the edge portion 113 which protrudes inward is formed. On both surfaces of the plate portion 110 on an outer peripheral side of the boss 112, the ring-shaped compressed convex portion 114 is formed respectively. The compressed convex portion 114 is not limited to a ring shape, and a plurality of compressed convex portions 114 may be formed in a spaced apart manner in a circumferential direction.

The positive electrode terminal 4 is made of aluminum, and has a rectangular plate shape. The positive electrode terminal 4 has the circular-hole-shaped recessed portion 41 on a first surface (outer surface) thereof. In a center portion of a bottom surface of the recessed portion 41, an insertion hole 42 into which the conductive shaft portion 121 is inserted is formed.

By swaging an end portion of the conductive shaft portion 121 to the recessed portion 41, the swaged portion 122 is formed so that the current collector 12 is mechanically and electrically connected to the positive electrode terminal 4. Unlike the negative electrode terminal 5, a plating layer is not formed on a surface of the positive electrode terminal 4. Both the positive electrode terminal 4 and the current collector 12 are made of aluminum and hence, galvanic corrosion does not occur at a portion where the swaged portion 122 and the positive electrode terminal 4 are brought into contact with each other.

The outer gasket 10 is made of a synthetic resin such as PPS or PP. The outer gasket 10 has a plate portion 100, an insertion hole 101, and an edge portion 102. The plate portion 100 is interposed between the outer surface of the lid plate 21 and an inner surface of the positive electrode terminal 4. The insertion hole 101 is formed at an approximately center portion of the plate portion 100, and the boss 112 is inserted into the insertion hole 101. On a peripheral edge of an outer surface of the plate portion 100, the edge portion 102 which protrudes outward is formed. The edge portion 102 covers a side surface of the positive electrode terminal 4.

In this embodiment, the negative electrode tabs 17 are disposed just below the conductive shaft portion 91 and hence, a current path from the negative electrode tabs 17 to the negative electrode terminal 5 is short. The conductive plate portion 90 is formed in a plate shape extending substantially parallel to the lid plate 21 and hence, a volume which the conductive plate portion 90 occupies in the case 2 is small. Accordingly, volume occupancy of the electrode assembly 3 in the case 2 is large and hence, energy density of the energy storage device 1 can be enhanced. In spite of the fact that a volume which the conductive plate portion 90 occupies in the case 2 is small, the inner surface of the conductive plate portion 90 to which the negative electrode tabs 17 are connected can ensure a large area. Accordingly, by setting respective sizes of the conductive plate portion 90 and the negative electrode tabs 17 in a planar direction of the lid plate 21 larger than a size of the negative electrode terminal 5, a contact area between the negative electrode tabs 17 and the conductive plate portion 90 can be increased so that a resistance loss in a current path in the energy storage device can be reduced. In the same manner, a current path from the positive electrode tabs 16 to the positive electrode terminal 4 is short, and a contact area between the positive electrode tabs 16 and the conductive plate portion 120 can be increased so that a resistance loss of the current path can be reduced. Accordingly, even when a large current flows in the energy storage device 1, the current path is minimally fused.

In this embodiment, the negative electrode terminal 5 has the plating layer 53 on the surface thereof, and the plating layer 53 is interposed between the swaged portion 92 and the negative electrode terminal 5. The plating layer 53 is made of Ni, and ionization tendency of Ni falls between ionization tendency of aluminum and ionization tendency of copper and hence, a potential difference between the swaged portion 92 and the plating layer 53 becomes smaller than a potential difference between the swaged portion 92 and the negative electrode terminal 5. Accordingly, the occurrence of galvanic corrosion is suppressed so that lowering of electric performance and the shortening of lifetime of the energy storage device 1 can be suppressed.

### Second Embodiment

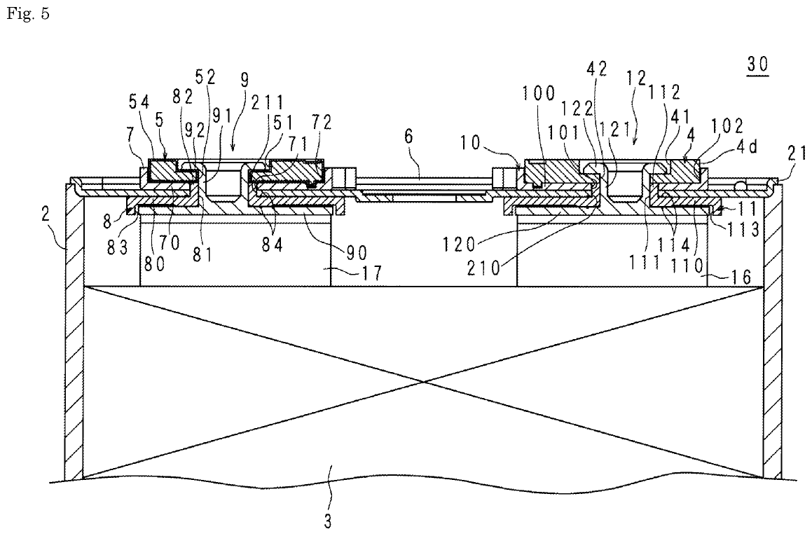

FIG. 5 is a partial cross-sectional view of an energy storage device 30 according to the second embodiment. In FIG. 5, parts identical with the parts in FIG. 4 are given the same symbols, and the detailed description of these parts is omitted.

The energy storage device 30 according to the second embodiment has substantially the same configuration as the energy storage device 1 according to the first embodiment except for a point that a negative electrode terminal 5 has an alumite treated layer 54 in place of the plating layer 53 of the first embodiment.

The alumite treated layer 54 is formed by alumite treatment. The alumite treatment is an anodic oxidation treatment where, using aluminum as an anode, a surface of aluminum is oxidized under an alumite treatment liquid thus forming an oxide film on the surface of aluminum.

It is sufficient that the alumite treated layer 54 is formed on at least a portion where the conductive shaft portion 91 and the negative electrode terminal 5 are brought into contact with each other.

In this embodiment, the negative electrode terminal 5 has the alumite treated layer 54 and hence, the portion where the conductive shaft portion 91 and the negative electrode terminal 5 are brought into contact with each other can exhibit favorable corrosion resistance. Accordingly, the lowering of electric performance and the shortening of lifetime of the energy storage device 1 can be suppressed.

The present invention is not limited to the contents of the embodiments described above, and various modifications are conceivable within the scope of the claims. Embodiments obtained by combining technical features suitably modified within the scope of the claims are also included in the technical scope of the present invention.

In the first embodiment and the second embodiment, the description has been made with respect to the case where the energy storage device 1 is a lithium ion secondary battery. However, the energy storage device 1 is not limited to the lithium ion secondary battery. The energy storage device 1 may be other secondary batteries such as a nickel hydrogen battery, may be a primary battery, or may be an electrochemical cell such as a capacitor.

### DESCRIPTION OF REFERENCE SIGNS

1, 30: energy storage device
2: case
20: case body
21: lid plate
3: electrode assembly
4: positive electrode terminal
41, 51: recessed portion
42, 52: insertion hole
5: negative electrode terminal
53: plating layer
54: alumite treated layer
6: rupture valve
7, 10: outer gasket
70, 100: plate portion
71, 101: insertion hole
72, 102: edge portion
8, 11: inner gasket
80, 110: plate portion
81, 111: insertion hole
82, 112: boss
83, 113: edge portion
84, 114: compressed convex portion
9, 12: current collector
90, 120: conductive plate portion
91, 121: conductive shaft portion
92, 122: swaged portion

1. An energy storage device comprising:
an outer case on which an external terminal is mounted;
an electrode assembly housed in the outer case;
a conductive shaft portion formed using a material different from a material for forming the external terminal, and having a swaged portion connected to the external terminal at one end thereof in an axial direction; and
a conductive plate portion housed in the outer case, to which the other end of the conductive shaft portion is connected, and the electrode assembly is connected,
wherein the external terminal has a plating layer or an alumite treated layer on a surface thereof which is brought into contact with the swaged portion.

2. The energy storage device according to claim 1, wherein the conductive plate portion is formed in a plate shape extending substantially parallel to a lid plate of the outer case, has a first surface to which the other end of the conductive shaft portion is connected, has a second surface to which a tab of the electrode assembly extending toward the lid plate is connected, wherein a size of the conductive plate portion and a size of the tab in a planar direction of the lid plate are set larger than a size of the external terminal in the planar direction of the lid plate.

3. The energy storage device according to claim 1, wherein ionization tendency of the plating layer is larger than ionization tendency of the conductive shaft portion, and is smaller than ionization tendency of the external terminal.

4. The energy storage device according to claim 1, wherein the external terminal is made of aluminum, and
the conductive shaft portion is made of copper.
